(19) United States
(12) Patent Application Publication
(10) Pub. No.: US 2016/0374328 A1
(43) Pub. Date: Dec. 29, 2016

(54) EXTENSION AND SUSPENSION MECHANISM FOR BOOM SPRAYER

(71) Applicant: Robert D. Beggs, Plainview, WI (US)

(72) Inventor: Robert D. Beggs, Plainview, WI (US)

(21) Appl. No.: 14/753,804

(22) Filed: Jun. 29, 2015

(51) Int. Cl. A01M 7/00; B05B 1/20; B05B 13/00

(52) U.S. Cl. CPC A01M 7/0053; B05B 13/005; B05B 1/20

(57) ABSTRACT

A boom sprayer having an inner boom section and an extendable outer boom section moved by a drive assembly including a pinch roller system. The boom sprayer included a suspension assembly including a shock absorbing material for enabling suspension of the outer boom section with respect to the inner boom section.

### FIELD OF THE INVENTON

The present invention relates generally to a boom sprayer, and more particularly to a telescoping boom sprayer having a plurality of telescoping booms carrying spray heads and moveable relative to one another. Still further, the present invention relates to a novel method and apparatus for extending the telescoping boom sprayer. The invention also relates to an improved method of spraying agricultural crops and the like with a boom sprayer.

### DESCRIPTION OF THE PRIOR ART

A variety of agricultural sprayers currently exist in the art. One common type of agricultural sprayer is a fixed boom or fixed length sprayer comprised of a tractor or other towing vehicle and a pair of articulated spray booms extending outwardly from opposite sides of the tractor or other towing vehicle. These booms, when extended, have a fixed length and are comprised of either single length booms or articulated boom sections which are folded in chicken wing fashion during non-use or transport. Agricultural sprayers and the like also exist which have a plurality of booms moveable relative to one another between an extended position and a retracted position.

Examples of existing spray implements include the McMahon U.S. Pat. No. 2,995,307 which discloses an articulated boom sprayer and the Nansel U.S. Pat. No. 3,055,594 which discloses an articulated, foldable boom type sprayer. The Atkinson U.S. Pat. No. 3,074,649 discloses a spraying apparatus having a single spray head at the end of a telescoping boom for spraying or washing a single element.

The High U.S. Pat. No. 2,962,307 discloses a plurality of extendable booms, with each boom having a plurality of spray heads. This patent discloses separate hoses and valves for each line of spray heads. Thus if it is desired for one spray head in a particular line to be used, all spray heads in that line must necessarily be used.

The DeWitt et al. U.S. Pat. No. 4,784,324 discloses a spraying apparatus for herbicidal and insecticidal application with an articulated and telescoping boom and with spray heads positioned on the boom.

Although many of the prior art sprayers, and in particular boom sprayers, are capable of spraying agricultural crops and the like over an extended width, they are generally incapable of spraying at lesser widths or at variable widths without a spraying overlap. Thus, to spray widths less than the maximum width of the sprayer, or to accommodate trees, posts or other obstacles that might be in the path of the sprayer booms, spraying overlap is necessary. This not only results in spraying more of the spray liquid than is needed and thereby increasing the spraying cost, but more importantly, results in double application or no application for portions of the crop being sprayed. This can lead to significantly reduced production for those areas or in some cases killing the crop as a result of over application.

Reference is also made to U.S. Pat. Nos. 6,085,993 and 6,491,234 to Beggs both disclosures of which are incorporated herein by reference. Both patents are directed to a boom sprayer having an inner boom section and an extendable outer boom section with a plurality of spray head valves. The '234 patent is also directed to a mechanism for attaching the spray booms to a support handle. As described in the '993 and '234 patents, the booms are equipped with a drive chain which extends substantially throughout the entire length of the inner boom section. During operation, the drive chain is engaged by the teeth of a toothed sprocket to drive and move the boom section between its extended and retracted positions.

While there are prior art boom structures which have extendible boom sections, there is a need for an improved boom sprayer and more particularly to an improved apparatus and process for extending the telescoping boom sprayer.

### SUMMARY OF THE INVENTION

The present invention is directed to a telescoping boom sprayer comprising a first, inner boom member, wherein the first, inner boom member is an elongated rigid structure comprising a plurality of rigid elongated frame members extending the length of the first, inner boom member from a proximal end of the first, inner boom member to a distal end of the first, inner boom member, wherein the first, inner boom member comprises a pair of horizontal platforms extending substantially the length of the first, inner boom member; and at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, wherein the pair of horizontal platforms assist in extending, retracting and supporting the second, outer boom member, and wherein the second, outer boom member includes a drive assembly mounted onto the proximal end of the second, outer boom member, the drive assembly comprising a pinch roller system. The pinch roller system comprises at least one pair of bottom drive rollers, at least one upper pinch drive roller frictionally engaging the horizontal platforms of the first, inner boom member, and a power source to activate the drive assembly.

The present invention is also directed to a telescoping boom sprayer comprising a first, inner boom member, wherein the first, inner boom section is an elongated rigid structure comprising a plurality of rigid elongated frame members extending the length of the first, inner boom member from a proximal end of the first, inner boom member to a distal end of the first, inner boom member, wherein the first, inner boom member comprises a pair of horizontal platforms extending substantially the length of the first, inner boom member; at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, and wherein the pair of horizontal platforms assist in extending, retracting and supporting the second, outer boom member; and a suspension assembly positioned at the distal end of first, inner boom member. The suspension assembly comprises a common spring shaft; and a pair of arms having first and second ends wherein the first ends of the arms are rotatably connected to the common spring shaft, wherein the common spring shaft is connected to the first end of a suspension spring arm and the second end of the suspension spring arm is connected to a suspension spring assembly, wherein the suspension spring assembly comprises shock absorbing material to provide shock absorbance in either direction of travel by the second, outer boom member, wherein the second ends of the arms are attached to a common shaft upon which is connected a pair of opposing trolley bars, wherein each of the pair of trolley bars supports at least one pair of suspension wheels, wherein the suspension wheels support the bottom frame members of the second, outer boom member as the second, outer boom member either extends from or retracts into the first, inner boom member.

The present invention is further direct to a telescoping boom sprayer, comprising a first, inner boom member, wherein the first, inner boom section is an elongated rigid structure comprising a plurality of rigid elongated frame members extending the length of the second outer boom member from a proximal end of the first, inner boom member to a distal end of the first, inner boom member, wherein the first, inner boom member comprises a pair of horizontal platforms extending substantially the length of the first, inner boom member; at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, and wherein the pair of horizontal platforms assist in extending, retracting and supporting the second, outer boom member; a drive assembly mounted onto the proximal end of the second, outer boom member, the drive assembly comprising a pinch roller system comprising at least one pair of bottom drive rollers, at least one upper pinch drive roller frictionally engaging the horizontal platforms of the first, inner boom member, and a power source to activate the drive assembly. The pinch roller system comprises powered drive wheels to extend the second, outer boom member, including two pairs of bottom drive rollers and at least one upper pinch drive roller, wherein the bottom drive rollers and the upper pinch roller frictionally engage the horizontal platforms of the first, inner boom member, an activatable chain sprocket, which rotates upon actuation of the power source, a drive roller chain, activatable by the chain sprocket, a series of rollers in concert with a series of freely rotating gears fixedly attached to the bottom rollers to mobilize the bottom rollers in the same direction, a rotatable gear fixedly attached to the upper roller in such a manner as to drive the upper roller in a rotating direction opposite the direction of rotation of the bottom rollers thus causing the extension or retraction of the second, outer boom member relative to the first, inner boom member, a rotatable boom center roller to assist the directional movement of the first, outer boom member, a boom extension limit stop block fixed on the horizontal platforms at the distal end of the first, inner boom member to prevent further extension of the first, outer boom member. The invention further includes a suspension assembly positioned at the distal end of first, inner boom member. The suspension assembly comprises a common spring shaft; a pair of arms having first and second ends wherein the first ends of the arms are rotatably connected to the common spring shaft, wherein the common spring shaft is connected to the first end of a suspension spring arm and the second end of the suspension spring arm is connected to a suspension spring assembly, wherein the suspension spring assembly comprises shock absorbing material to provide shock absorbance in either direction of travel by the second, outer boom member, wherein the second ends of the arms are attached to a common shaft upon which is connected a pair of opposing trolley bars, wherein each of the pair of trolley bars supports at least one pair of suspension wheels, wherein the suspension wheels support the bottom frame members of the second, outer boom member as the second, outer boom member either extends from or retracts into the first, inner boom member; and a spray material supply conduit mounted to first, inner boom member and extending the entire length of the first, inner boom and second, outer boom members, and further comprising a plurality of spray nozzles positioned in spaced relationship along the entire length of the supply conduit and the first, inner boom and second, outer boom members.

The present invention is also directed to a method of agricultural spraying with a telescoping boom sprayer, comprising the steps of:

1. providing at least one telescoping boom sprayer on a support vehicle, the boom sprayer including a first, inner boom member, wherein the first, inner boom section is an elongated rigid structure comprising a plurality of rigid elongated frame members extending the length of the first, inner boom member from a proximal end of the first, inner boom member to a distal end of the first, inner boom member, wherein the first, inner boom member comprises a pair of horizontal platforms extending substantially the length of the first, inner boom member, at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, and wherein the pair of horizontal platforms assist in extending, retracting and supporting the second, outer boom member, a drive assembly mounted onto the proximal end of the second, outer boom member, the drive assembly comprising a pinch roller system comprising at least one pair of bottom drive rollers, at least one upper pinch drive roller frictionally engaging the horizontal platforms of the first, inner boom member, and a power source to activate the drive assembly, and a suspension assembly positioned at the distal end of first, inner boom member, the suspension assembly comprising a common spring shaft, a pair of arms having first and second ends wherein the first ends of the arms are rotatably connected to the common spring shaft, wherein the common spring shaft is connected to the first end of a suspension spring arm and the second end of the suspension spring arm is connected to a suspension spring assembly, wherein the suspension spring assembly comprises shock absorbing material to provide shock absorbance in either direction of travel by the second, outer boom member, wherein the second ends of the arms are attached to a common shaft upon which is connected a pair of opposing trolley bars, wherein each of the pair of trolley bars supports at least one pair of suspension wheels, wherein the suspension wheels support the bottom frame members of the second, outer boom member as the second, outer boom member either extends from or retracts into the first, inner boom member;

2. providing a spray material supply conduit mounted to first, inner boom member and extending the entire length of the first, inner boom and second, outer boom members, and further comprising a plurality of spray nozzles positioned in spaced relationship along the entire length of the supply conduit and the first, inner boom and second, outer boom members;

3. actuating the drive assembly to extend the second, outer boom member to a desired location with respect to the first, inner boom member; and

4. actuating the spray nozzles.

Thus, the present invention relates to an improved telescoping boom sprayer which can spray crops and the like from a width of 75 feet to 150 feet or more and any width inbetween, with no spray overlap and with a single spray material supply to the extendable boom. Further, the boom sprayer in accordance with the present invention can fold up into a compact structure for transport during non-use. Further, the present invention provides a more efficient manner of extending the boom structure.

The present invention also provides an improved means for connecting the boom sprayer to the support or towing vehicle. This means includes a rear gantry which is both self-leveling and is capable of independent actuation for each spray boom. The specific structure of the support means includes a pendulum-type support which is pivotally connected to the support vehicle. The pendulum includes shock absorbers which stabilize the rotational movement of the support relative to the vehicle and a pair of parallel linkages to support the respective booms so that they can be raised and lowered independently of one another.

One advantage of the present invention is that instead of having a chain running all the way down the boom to extend or retract the secondary boom structure, the current adjustable booms have hydraulically powered drive wheels to move the sections, which reduces the number of moving parts. Extending to full width or pulling in to the narrow width happens very quickly.

The boom structure of the present invention is sturdier for the more diverse farm and commercial market. In addition, the boom sprayer of the present invention provides a lighter overall sprayer weight, larger swath, increase in machine control and better allocation of horsepower, which ultimately cuts down on operation hours. Fewer hours on a machine allow the operator more timely applications, a significantly higher trade in value, and less physical deterioration of equipment.

The spray boom system of the present invention is lighter than its steel counterpart, while remaining just as robust. As the agricultural implements of today increase in size, the necessity of sprayers to follow suit has been addressed by prevailing grower-operator markets. The larger volume capacity and weight of the modern sprayer calls for a lighter—and wider—boom option.

The objects and advantages of the invention will appear more fully from the following detailed description of the preferred embodiment of the invention made in conjunction with the accompanying drawings.

### DESCRIPTION OF THE DRAWINGS

FIG. 1 is an elevational side view of the boom sprayer in accordance with the present invention showing the boom assembly attached to a support vehicle and in a retracted, transport or non-use position.

FIG. 1A is an elevational side view of the boom sprayer of FIG. 1, illustrating the spray heads on the boom assembly.

FIG. 2 is a perspective view of the boom sprayer in accordance with the present invention showing one of the boom assemblies in a fully extended, spray position.

FIG. 3 is a perspective view of the drive assembly of the boom sprayer.

FIG. 4 is a partial cutaway side elevational view of the drive assembly of FIG. 3 taken at lines 4-4 of FIG. 3.

FIG. 5 is a partial cutaway perspective view of the drive assembly of FIG. 4.

FIG. 6 is a partial perspective view of the drive assembly of FIG. 3 illustrating the boom centering roller.

FIG. 7 is a partial perspective view of the drive assembly of FIG. 3 illustrating the hydraulic stop switch.

FIG. 8 is a perspective view of the drive assembly of FIG. 3 illustrating the conveyor belt and hoses.

FIG. 9 is a perspective view of the suspension assembly of the boom sprayer system.

FIG. 10 is a further perspective view of the suspension assembly of the boom sprayer system.

FIG. 11 is a partial cutaway, elevated side view of the suspension assembly of the boom sprayer system of FIG. 9 taken at lines 11-11 of FIG. 9.

FIG. 12 is a perspective view of the boom sprayer of FIG. 1 showing the boom assembly attached to a support vehicle and in a partially extended position.

FIG. 13 is a perspective view of the boom sprayer of FIG. 12 showing the boom assembly attached to a support vehicle and in a further extended position.

FIG. 14 is a perspective view of the boom sprayer of FIG. 1 showing the boom assembly attached to a support vehicle and showing the breakaway system in a partially extended position.

FIG. 15 is a rear elevated view of the boom sprayer of FIG. 1 showing the boom assembly attached to a support vehicle and in a fully extended position.

### DESCRIPTION OF THE PREFERRED EMBODIMENT

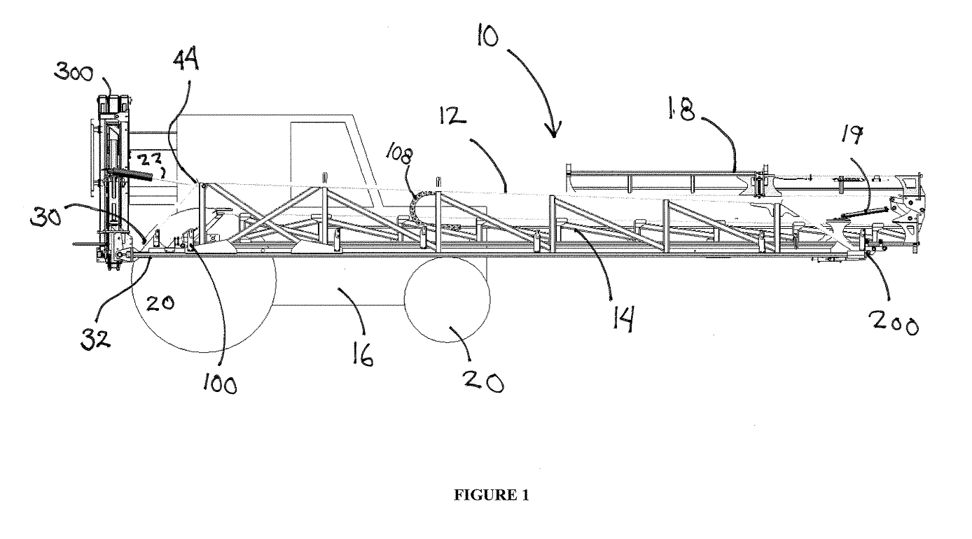

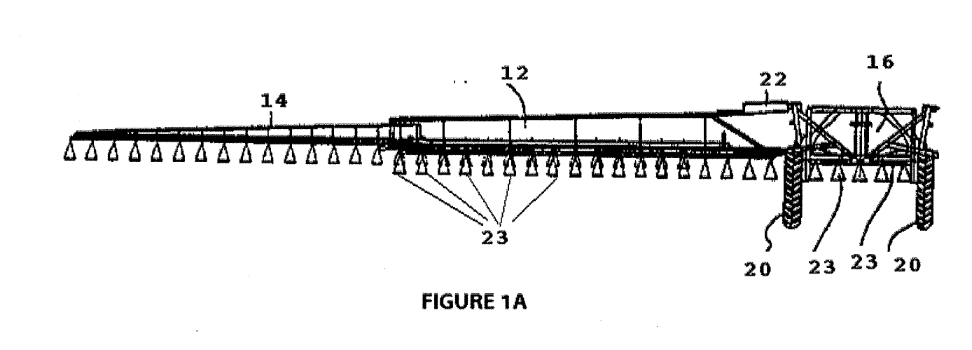

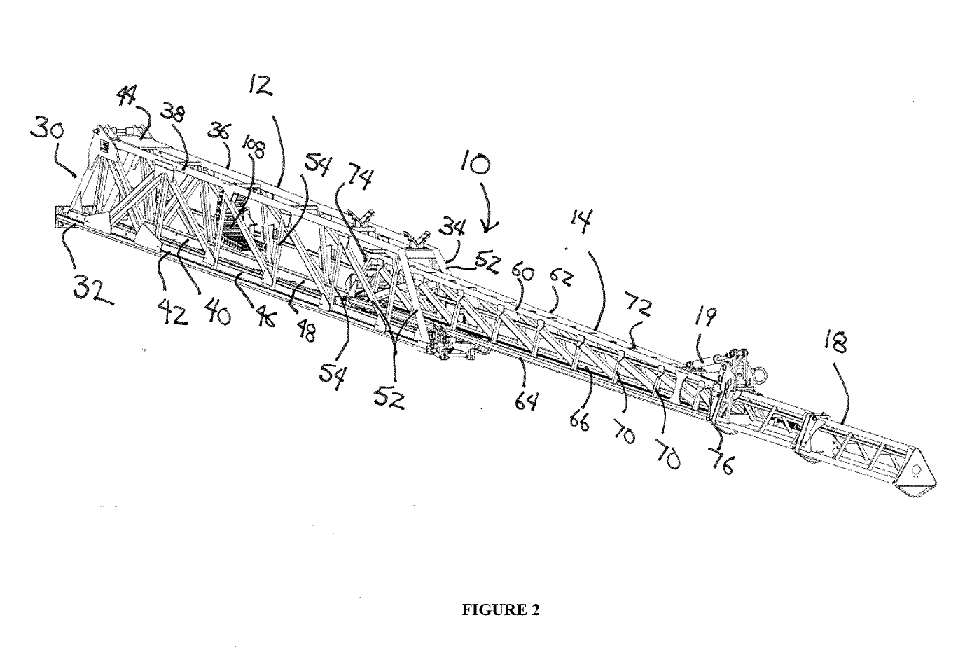

The present invention relates to a telescoping boom sprayer 10 designed primarily for agricultural use which can spray variable widths with no spray overlap. The boom sprayer 10 in accordance with the preferred embodiment is illustrated generally in FIGS. 1-2. In general, the boom sprayer 10 of the present invention includes a pair of boom assemblies each comprising a first or inner boom member or boom 12 and a second or outer boom member or boom 14. In the preferred embodiment, the inner boom 12 is a fixed boom section and the outer boom 14 is an extendable boom section. The outer boom 14 is not rigidly attached to the inner boom 12.

FIG. 1 shows the booms 12 and 14 in a fully retracted transport or non-use position mounted to a support or towing vehicle 16. FIG. 2 shows the booms 12 and 14 in a fully extended position relative to the vehicle 16. Only one boom assembly is shown in FIG. 2. In actuality, a second identical boom assembly extends from the opposite side of the vehicle 16 shown in FIG. 2.

The vehicle 16 can, if desired, be a conventional tractor or other vehicle which has been adapted to receive the boom sprayer elements of the present invention or may be a vehicle which is designed for and dedicated solely to the boom sprayer components of the present invention. The vehicle 16 includes ground engaging means in the form of a plurality of wheels 20. Preferably, the tractor 16 includes a source of hydraulic fluid power to drive the boom extension motor and the various boom positioning cylinders as described in greater detail below. As best described in U.S. Pat. No. 6,491,234, the disclosure of which is incorporated herein by reference in entirety, the vehicle 16 also includes a spray conduit extending across the rearward end of the vehicle 16 and a plurality of spray heads 23, as illustrated in FIG. 1A, positioned in spaced relationship along the conduit. A plurality of hydraulic cylinders 22 and/or other power means are provided for pivoting the boom assemblies about both a generally horizontal axis as well as a generally vertical axis to enable the boom assemblies to be moved between an operative or spray position as shown in FIG. 2 and a folded or transport position as shown in FIG. 1. Such power means is common in the art with respect to boom sprayers and is thus not shown in greater detail.

Although the preferred embodiment shows each boom assembly as comprised of an inner boom section 12 and an outer boom section 14, more extendable boom sections can be utilized without departing from the features of the present invention. Such a structure could involve additional extendable boom sections moveable relative to other extendable sections.

The first or inner boom section 12 is an elongated, rigid structure having a longitudinal axis in the direction of its elongation, an inner or proximal end 30 mounted to the vehicle 16 about a generally horizontal axis 32 and an outer or distal free end 34 extending outwardly from the vehicle 16.

With continuing reference to FIGS. 1-2, the elongated inner boom 12 is shown to have a generally quadrilateral cross-sectional configuration having a pair of continuous generally cylindrical top frame members 36, 38 and a pair of continuous bottom frame members 40, 42. The bottom frame members 40, 42 extend throughout the entire length of the boom section 12, while the top frame members 36, 38 extend throughout a substantial portion of the length of the boom section 12. The proximal end 44 of the top frame members 36, 38 may be connected with the hydraulic cylinder 22 (FIG. 1) for raising and lowering the boom sprayer assembly 10.

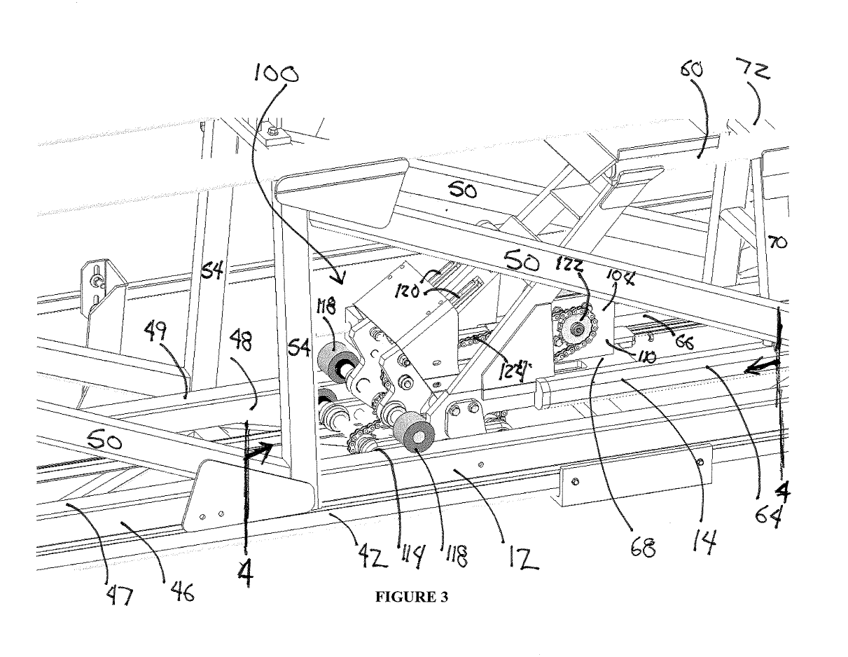

As illustrated in FIGS. 2 and 3, a pair of 90 degree angle irons 46, 48 having horizontal platforms 47, 49 also extend substantially along the entire length of the inner boom 12 to assist in extending, retracting and supporting the outer boom section 14 and to also provide rigidity to the inner boom section 12. In the preferred embodiment, as shown best in FIG. 3, the bottom, vertical edges of the angle irons 46, 48 are rigidly connected to a portion of the top outer surface of the bottom frame members 40, 42 by welding or the like. The configuration of the boom section 12 is braced at its ends and at spaced locations between its ends by a plurality of braces 50. The brace members 50 extend downwardly and inwardly from the inner end of the top frame members 36, 38 for connection to the bottom frame members 40, 42. A pair distal end brace members 52 are positioned at the distal or outer end of the inner boom section 12.

As shown best in FIGS. 2 and 3, a plurality of spaced, intermediate brace members 54 extend downwardly from the top frame members 36, 38 for rigid connection by welding or the like to the bottom frame members 40, 42. As shown best in FIG. 2, the cross-section size of the quadrilateral inner boom 12 decreases from its proximal end 30 adjacent to the towing vehicle or tractor 16 to its outer free end.

The structure of the outer boom is illustrated best in FIGS. 1 and 2. Similar to the inner boom section 12, the outer boom section 14 is an elongated, rigid structure comprised of a plurality of rigid elongated frame members including a pair of top frame members 60, 62 and a pair of bottom frame members 64, 66. Both the top frame members 60, 62 and the bottom frame members 64, 66 extend generally along the entire length of the outer boom section 14 from the proximal end 74 of the outer boom section 14 to the distal end 76. A plurality of bottom, laterally extending brace members 68, a plurality of side brace members 70 and a plurality of top laterally extending brace members 72 are spaced longitudinally along the outer boom section 14 and are connected to the top frame members 60, 62 and the bottom frame members 64, 66 by welding or the like.

Both the inner boom 12 and outer boom 14 may be constructed of any material rigid and strong enough to withstand the stresses in the booms such as steel or aluminum, among possible others.

Rigidity in boom structure is not desired. It is important to allow the entire boom structure to flex. Thus, the desired material for making the booms is aluminum, and preferably a blend of aluminums 6063t and 5052 (Alcoa Distribution and Industrial Products, Cressona, PA). Aluminum 6063t is an alloy including magnesium and silicon as the alloying elements and is weldable. Therefore, it can be heat treated and has good strength. Aluminum 5052 is an alloy used in a lot of manufacturing because it can be easily extruded and has a smooth finish that can be anodized. All bushings throughout are preferably stainless steel, including pressed-in stainless steel bushings at every aluminum pivot hole. Using fluted or corrugated tubing in the bottom frame members 40, 42 of each of the booms helps keep them light without sacrificing strength.

Among the vast improvements incorporated in the boom structure design is the manufacture of two bottom rails with fluted (integrated) tubing, extruded into an angle ‘L’ shaped design which makes it three times stronger. Fluted tubing is used through all three sections of the boom; primary, secondary and breakaway.

The pivoting breakaway system 18 is also shown on the boom sprayer 10 in order to handle the tip abuse all boom sprayers 10 endure during long hours in the field. While not required, the breakaway system 18 is beneficial as it has the capability of flexing forward and backward (horizontal plane breakaway), as well as straight up (vertical plane breakaway). Such a simple design allows for a reduced number of parts, and consequently relieving the endemic amount of maintenance of the boom sprayer 10 set up. As illustrated in FIG. 1, the breakaway system 18 is hingedly attached to the outer boom section 14. When not in use, the breakaway system is hingedly rotated to rest upon the inner boom section 12 as illustrated in FIG. 1. In use, as illustrated in FIG. 2, the breakaway system 18 extends beyond the outer boom section 14.

The ultimate purpose of the boom sprayer units 10 is to provide fertilizers and chemicals to crops. To that end, a spray material supply conduit is typically mounted to one side of the inner boom section 12 by a plurality of spaced mounting brackets. The spray supply conduit extends along the entire length of the boom 12 and includes a plurality of spray heads 23 or spray nozzles (not shown) positioned in spaced relationship along the entire length of the supply conduit and the boom 12. In the preferred embodiment, these spray heads 23 are not provided with valves. Thus, they are continuously in communication with the interior of the supply conduit so that spray material provided to the conduit will exit through the spray nozzles. It should be noted that if spraying is desired at only the outer boom section 14 outwardly of the boom section 12, the conduit and nozzles can be eliminated or the spray material valve to the conduit turned off. A representative description and illustration of the spray system, including the spray heads 23 illustrated in FIG. 1A, can be found in U.S. Pat. No. 6,491,234 and applies equally to the presently described system.

The means for driving and supporting the outer boom section 12 for outward and inward movement relative to the inner boom section 11 includes a pinch roller drive assembly or simply drive assembly 100 and a suspension assembly 200. The locations of the drive assembly 100 and the suspension assembly 200 on the boom sprayer 10 are shown best in FIGS. 1 and 2.

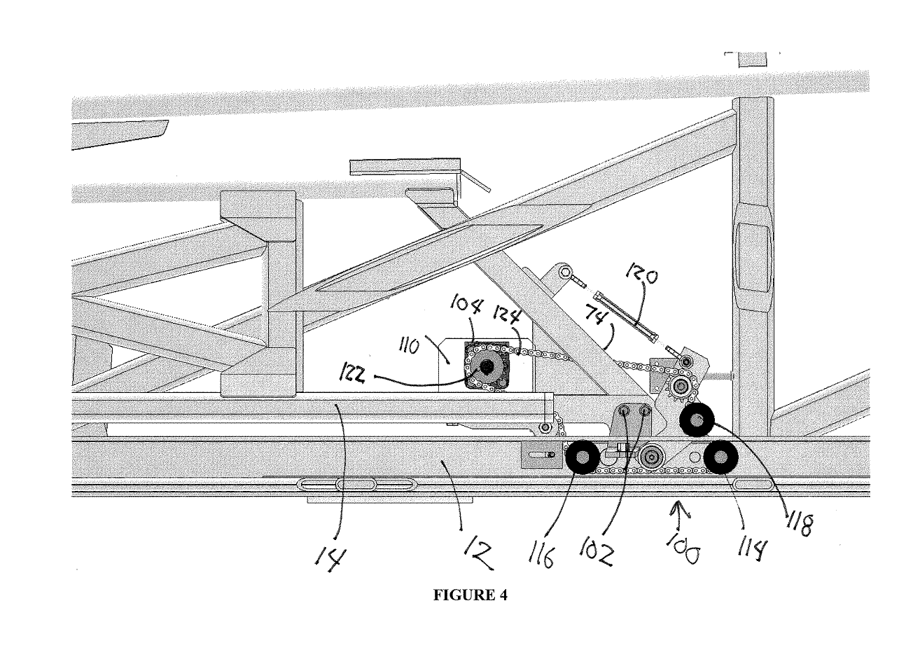

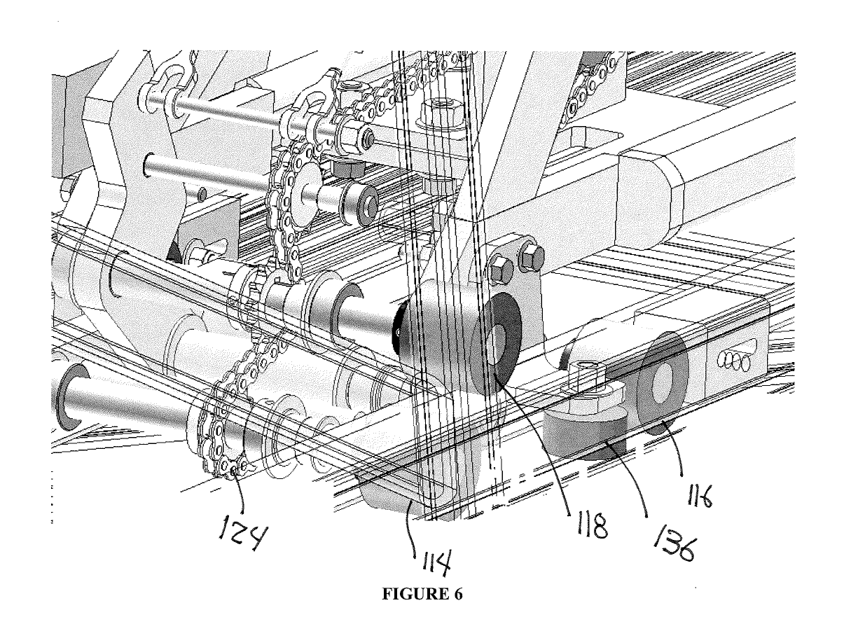

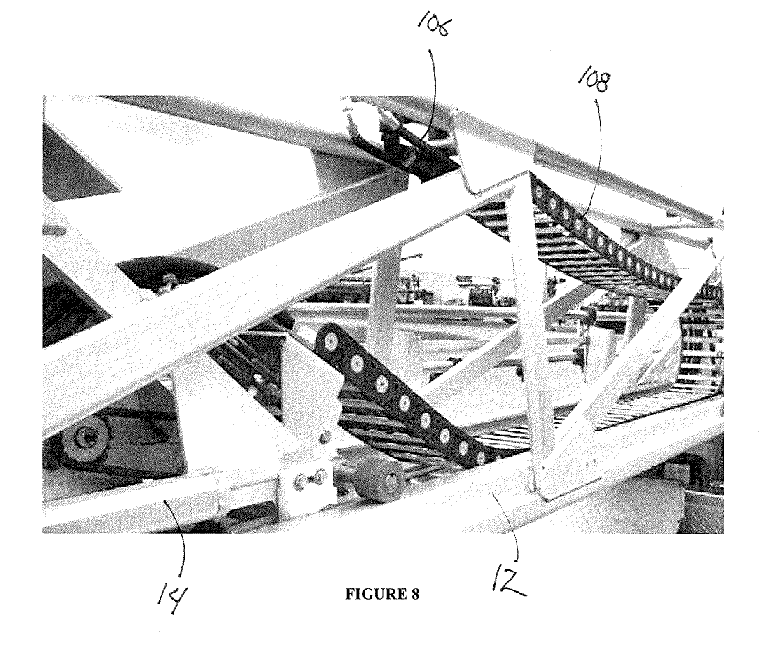

Referring now to FIGS. 3-8, the drive assembly 100 is mounted onto the proximal end 74 of the outer boom 14 by mounting screws 102, welding or other known attachment means. In the preferred embodiment, the drive assembly 100 includes a power source to activate the drive assembler 100. Without wishing to be restricted to one power source, a preferred power source is a hydraulic motor 104. The hydraulic motor 104 is driven by a source of hydraulic fluid power from the vehicle 16. A plurality of fluid lines 106, illustrated in FIG. 8, extend from the power source to the hydraulic motor 104. Sufficient lines and connections are needed to selectively drive the motor 104 in both a forward and a reverse direction. As illustrated in FIG. 8, the fluid line 106 can be surrounded and encompassed by a flexible cable carrier 108, of sufficient strength, mobility and integrity to prevent trauma and rupture of the fluid lines 106.

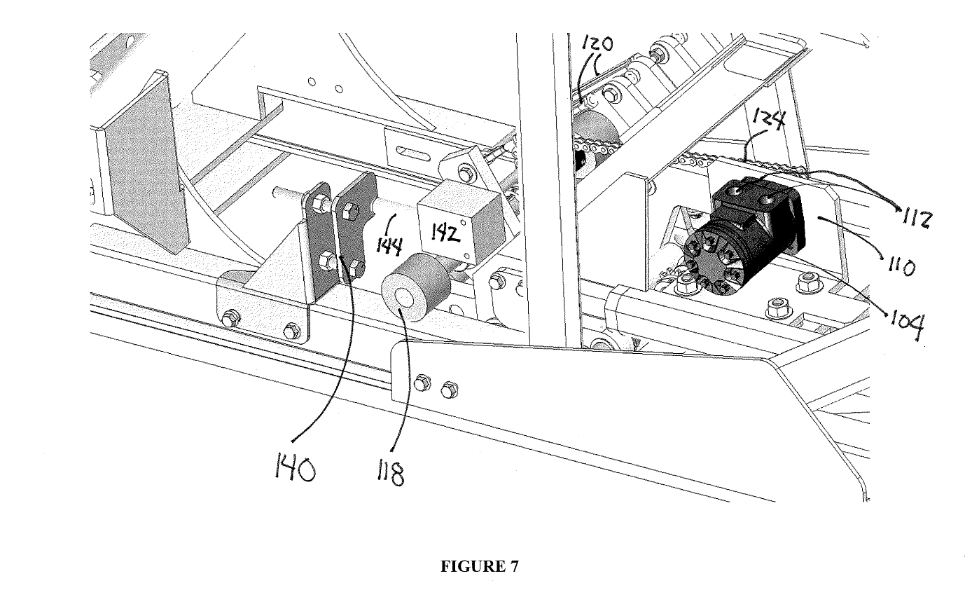

The hydraulic motor 104 is directly attached to a mounting plate 110 on the drive assembly 100 as shown in FIG. 7. The fluid lines 106 attach to the hydraulic motor 104 via fluid line inputs 112.

Instead of having a chain extending the length of the inner boom 12 to extend or retract the outer boom 14, as is typical of prior art extension systems, the drive assembly 100 of the boom sprayer 10 of the present invention includes hydraulically powered drive wheels to extend the outer boom 14, which advantageously reduces the number of moving parts. This is accomplished by a pinch roller system which includes at least one and preferably two pairs of bottom drive rollers 114, 116 and at least one upper “pinch” drive roller 118. The two bottom drive rollers 114, 116 and the upper “pinch” roller 118 frictionally engage the horizontal platforms 47, 49 of the angle irons 46, 48, both of which extend the length of the inner boom 12. The horizontal platforms 47, 49 thus provide a rail track for the upper and bottom rollers 114, 116, 118. The frictional engagement causes the drive assembly 100 to interact with the angle irons 46, 48. Adjustable turnbuckles 120, known to the art, can be activated to adjust the frictional tension between the upper and bottom rollers 114, 116, 118.

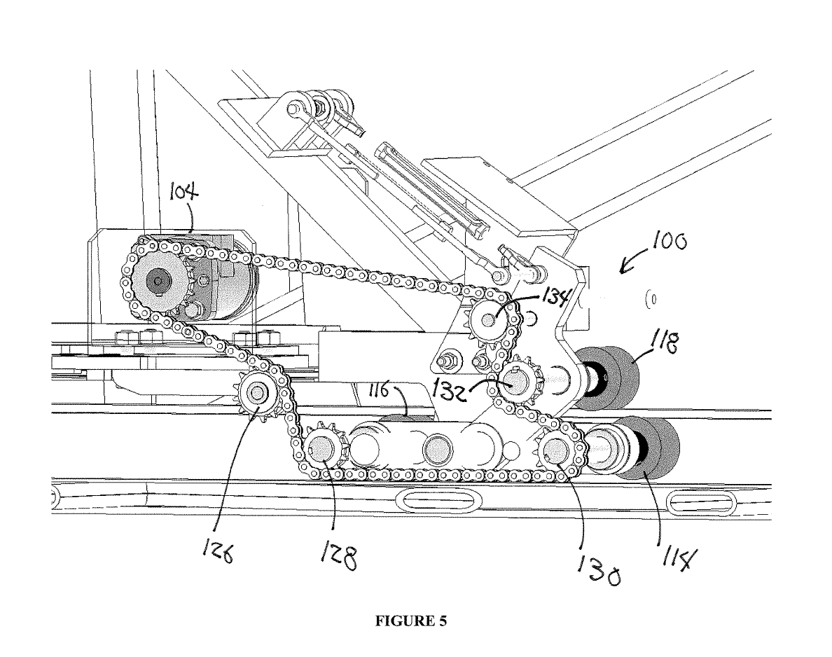

As illustrated in FIGS. 3-5, the hydraulic motor 104 includes an activatable chain sprocket 122, which rotates upon actuation of the hydraulic motor 104. The chain sprocket 112 is designed to move the drive roller chain 124 along a pathway designed to rotate the upper and bottom rollers 114, 116, 118. As best illustrated in FIG. 5, the roller chain 124 follows a defined path along a series of freely rotating gears 126, 128, 130, 132, 134. As shown, gears 128 and 130 are fixedly attached to bottom rollers 114 and 116 in such a manner to cause the bottom rollers to move in the same direction, either both moving in a clockwise or both moving in a counterclockwise direction. Gear 132 is fixedly attached to upper roller 118. However, the roller chain 124 is mounted on gear 132 in such a manner as to drive the upper roller 118 in a rotating direction opposite the direction of rotation of the bottom rollers 114 and 116, thus causing the drive assembly 110, and therefore the attached outer boom 14 to move along the rail track provided by the horizontal platforms 47, 49, thereby causing the outer boom 14 to extend in an outwardly direction from the inner boom 12, as illustrated in FIG. 2, or retract within the inner boom 12, as illustrated in FIG. 1.

A rotatable boom center roller 136 may be provided on both sides of the drive assembly 110 to assist the directional movement of the outer boom 14. The center roller 136 is designed to freely rotate along the inner walls of the angle irons 46, 48. In addition, a boom extension limit stop block 138, made of sound structural material such as metal or heavy rubber, may be fixed along the inner wall of the angle irons 46, 48 at the distal end 52 of the inner boom 12 to prevent further extension of the outer boom 14. At the proximal end 30 of the inner boom 12, at least one of the angle irons 46, 48 may be provided with an adjustable retraction stop 140 to prevent retraction of the outer boom 14 beyond a desired location. The adjustable retraction stop 140 works in concert with a hydraulic stop switch 142 which include an activatable and moveable button 144. When the outer boom 14 is sufficiently retracted within the inner boom 12, the button 144 will align with the retraction stop 140. Upon further movement, the button 144 will be depressed within the stop switch 142 thereby activating a “kill” mechanism to stop further retraction movement of the outer boom 14.

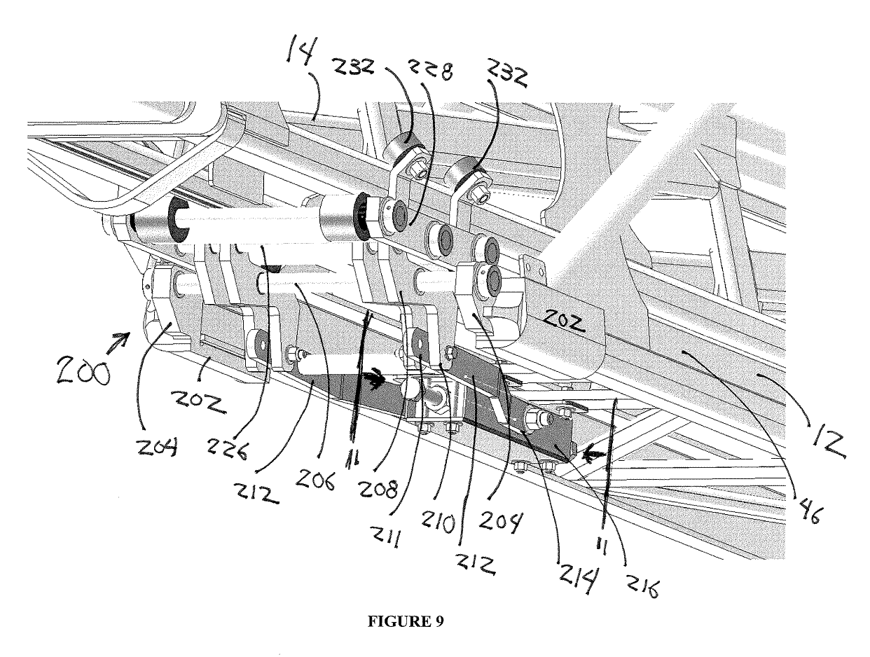

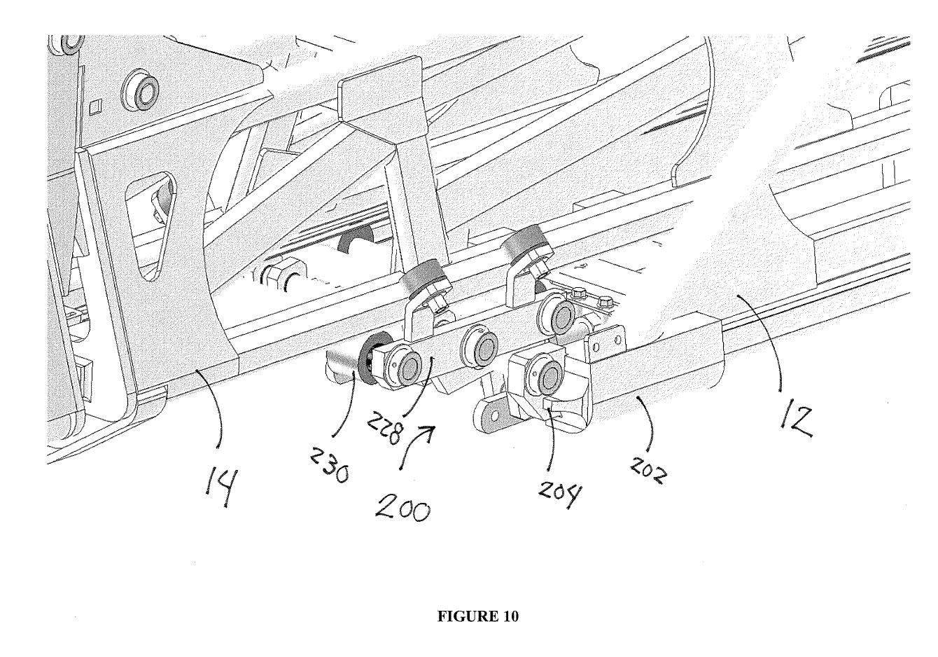

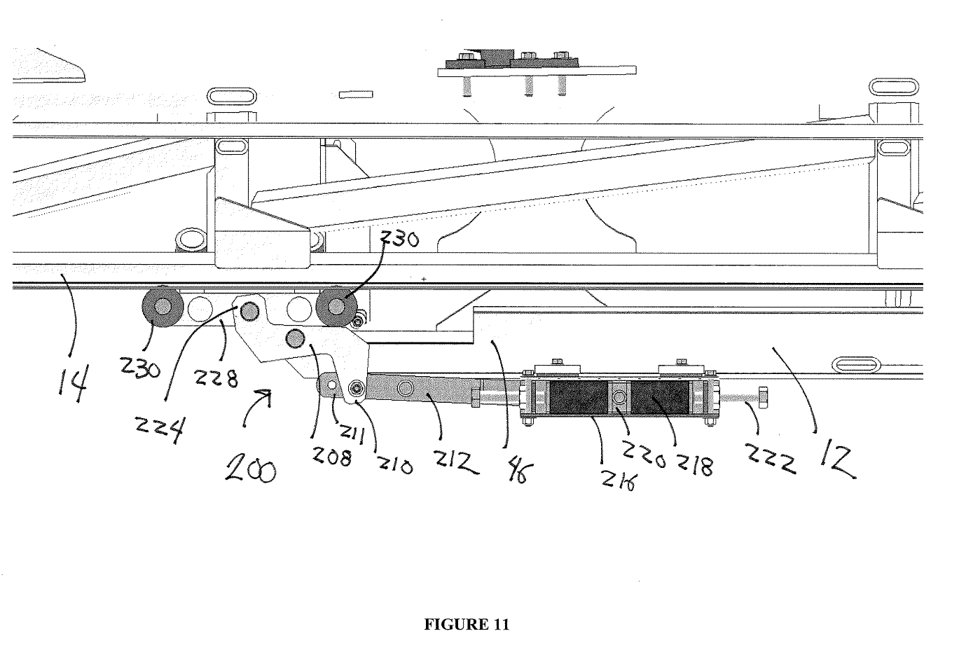

The distal end 34 of the inner boom section 12 is provided with a suspension assembly 200 illustrated best in FIGS. 9-11. The supporting structure for the suspension assembly includes the proximal ends of the angle iron members 46, 48. The angle iron members 46, 48 are rigidly secured to corner members 202. Located at the distal ends of both corner members 202 are mounts 204 for receiving a common spring shaft 206. A set of Z-shaped arms 208 is rotatably connected to the common spring shaft 206. One end 210 of the springs 208 is connected to a first end 211 of a suspension spring arm 212. The other end 214 of the suspension spring arm 212 is connected to the suspension spring assembly 216. The suspension spring assembly 216 comprises shock absorbing material 218 connected to a block 220 which in turn is connect to each ends 214 of the suspension spring arm 212. As illustrated in FIG. 11, the block 220 is interiorly placed within the shock absorbing material 218 to provide shock absorbance in either direction of travel. The absorbency of the material 218 can be adjusted by a screw-type adjuster 222.

The other ends 224 of the Z-shaped arms 208 are attached to a common shaft 226. Situated at each end of the common shaft 226 is a pair of opposing trolley bars 228, each of which supports at least one pair and preferably two pairs of suspension wheels 230. The purpose of the suspension wheels 230 are to support the bottom frame members 64, 66 of the outer boom 14 as the boom 14 either extends from or retracts into the inner boom 12. A pair of flanged guide wheels 232 is situated on each side of the inner boom 12 to keep the outer boom 14 aligned as it extends or retracts.

Preferably, the shock absorbing material 218 is a polyurethane block, such as 65 Durometer Neoprene shock absorption material, to give flexibility to the extended boom 14 when the boom 14 is in operation. While the polyurethane block is preferred, conventional springs and shock absorbers could also be used. The suspension assembly 200 allows sufficient flexibility to take the stress off the entire boom system 10. Further, the suspension assembly 200 relieves the stress of the extended length of the outer boom 14 to allow the boom sprayer 10 reach longer lengths without the requirement of support wheels.

Therefore, when the boom sprayer 10 bounces around on a field, the outer boom 14 is not rigidly attached to the inner boom 12. The suspension assembly 200 allows better suspension as the outer boom 14 extends. Thus, the suspension assembly 200 simultaneously acts as a spring and a shock absorber.

Having described the structure of the preferred embodiment in detail, the operation and method of the boom sprayer 10 of the present invention can be understood best as follows.

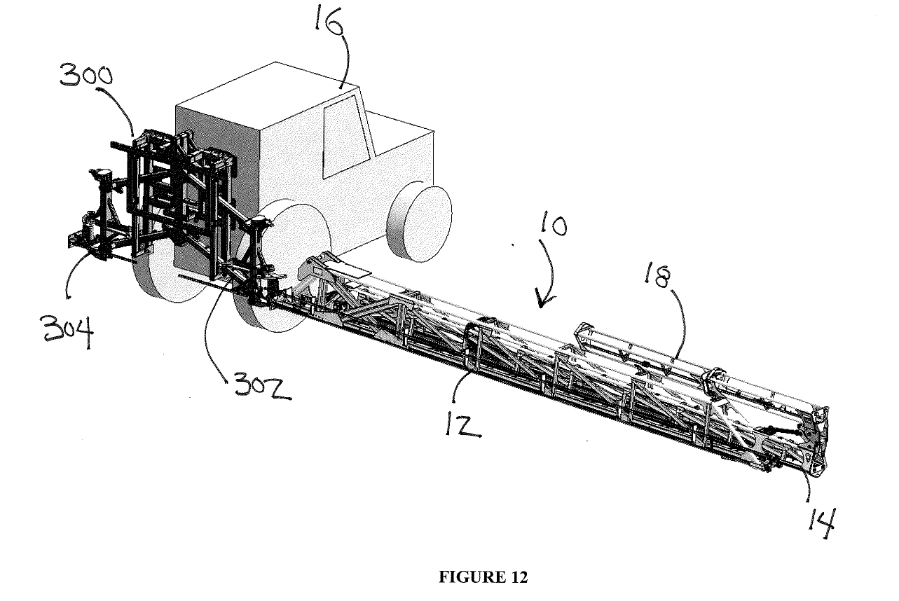

First, when not in use, or during transport, the boom sprayer 10 is fully retracted and pivoted inwardly to the position illustrated in FIG. 1. To operate the boom sprayer 10 of the present invention for spraying an agricultural crop or the like, the boom assemblies comprising the inner and outer boom sections 12 and 14 on each side of vehicle 16 are pivoted outwardly and lowered to a desired height above the crop by the hydraulic cylinder 19 and power means (not illustrated) to a position similar to that illustrated in FIG. 12, with the outer boom section 14 still retracted and the breakaway system 18 folded upon the inner boom 12. In this position, the boom section 12 is fully operable as a boom sprayer 10 to spray at a width defined by the combined lengths of the boom sections 12 as described in U.S. Pat. No. 6,491,234.

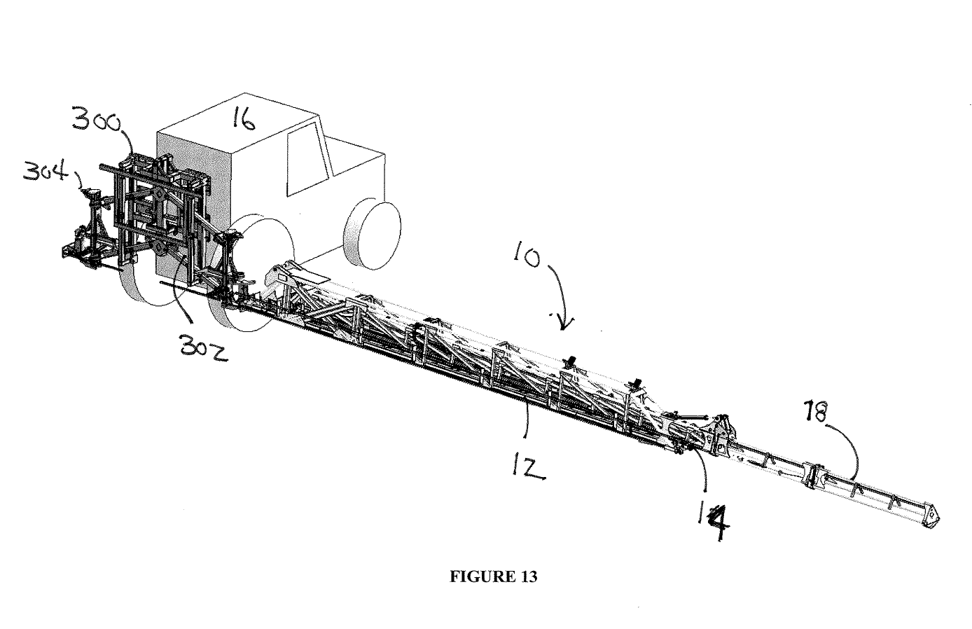

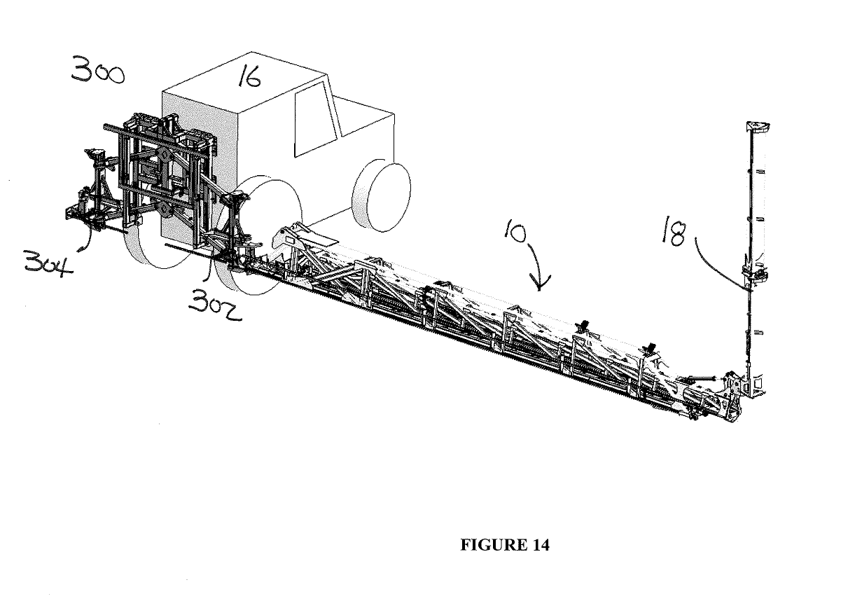

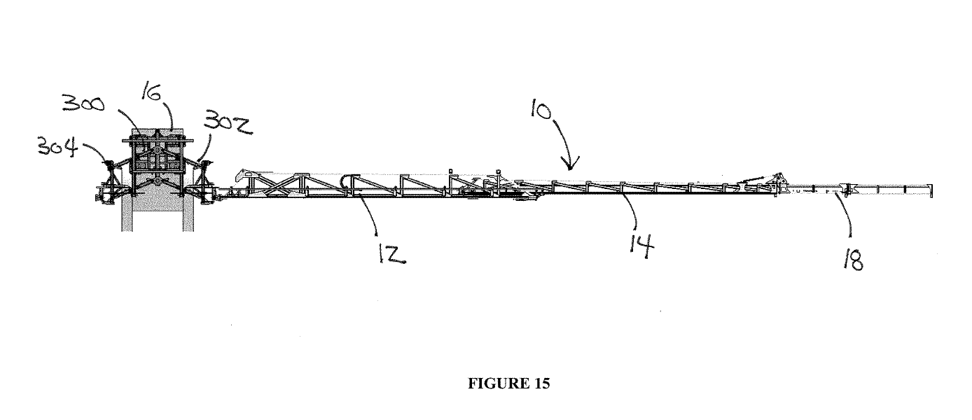

If it is desired to spray a greater width, the drive assembly 100 (FIG. 3) is actuated by hydraulic power to activate the hydraulic motor 104, which rotates the chain sprocket 122 to engage the drive roller chain 124. This activates the movement of the pinch drive system comprising the bottom drive rollers 114 and 116 and the upper drive roller 118. Because of engagement between the teeth of the sprocket 122 and the drive roller chain 124 are connected with the boom section 14, the boom section 14 is extended as illustrated in FIG. 13. During this movement, the boom section 14 is supported in rolling engagement relative to the boom section 12 via the suspension assembly 200 described previously. If further extension is required, the breakaway system 18 may be hydraulically actuated to extend itself, illustrated in FIG. 14 until the entire boom sprayer 10 is fully extended as illustrated in FIG. 15.

To retract the outer boom section 14 from the position shown in FIG. 15 to that shown in FIG. 1, the above process is reversed. During this movement, rotation of the hydraulic motor 104 and thus chain sprocket 122 is reversed to move the boom section 14 inwardly.

The spray booms in accordance with the present invention as described above can be connected to the support or towing vehicle 14 in a variety of ways. Preferably, in accordance with the present invention, the spray booms are mounted in such a way that the booms are both self-leveling as well as being capable of independent actuation. More specifically, as shown in FIGS. 1 and 12-15, the spray boom assembly 10 includes a support member or pendulum 300 which is pivotally secured to the frame of the towing vehicle 16. The assembly 300 also includes a pair of parallel lift linkages 302 and 304 for raising and lowering the individual spray booms on each side of the vehicle.

Any version of any component or method step of the invention may be used with any other component or method step of the invention. The elements described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference in their entirety to the same extent as if each individual reference were specifically and individually indicated as being incorporated by reference. In case of conflict between the present disclosure and the incorporated references, the present disclosure controls.

The devices, methods, compounds and compositions of the present invention can comprise, consist of, or consist essentially of the essential elements and limitations described herein, as well as any additional or optional steps, ingredients, components, or limitations described herein or otherwise useful in the art.

While this invention may be embodied in many forms, what is described in detail herein is a specific preferred embodiment of the invention. The present disclosure is an exemplification of the principles of the invention is not intended to limit the invention to the particular embodiments illustrated. It is to be understood that this invention is not limited to the particular examples, process steps, and materials disclosed herein as such process steps and materials may vary somewhat. It is also understood that the terminology used herein is used for the purpose of describing particular embodiments only and is not intended to be limiting since the scope of the present invention will be limited to only the appended claims and equivalents thereof.

1. A telescoping boom sprayer comprising:
a. a first, inner boom member, wherein the first, inner boom member is an elongated rigid structure comprising a plurality of rigid elongated frame members extending the length of the first, inner boom member from a proximal end of the first, inner boom member to a distal end of the first, inner boom member, wherein the first, inner boom member comprises a pair of horizontal platforms extending substantially the length of the first, inner boom member; and
b. at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, wherein the pair of horizontal platforms assist in extending, retracting and supporting the second, outer boom member, and wherein the second, outer boom member includes a drive assembly mounted onto the proximal end of the second, outer boom member, the drive assembly comprising a pinch roller system comprising:
i. at least one pair of bottom drive rollers,
ii. at least one upper pinch drive roller frictionally engaging the horizontal platforms of the first, inner boom member, and
iii. a power source to activate the drive assembly.

2. The telescoping boom sprayer of claim 1, wherein the power source is a hydraulic motor driven by a source of hydraulic fluid power from a support vehicle.

3. The telescoping boom sprayer of claim 1 wherein a pinch roller system comprises:
a. powered drive wheels to extend the second, outer boom member;
b. two pairs of bottom drive rollers and at least one upper pinch drive roller, wherein the bottom drive rollers and the upper pinch roller frictionally engage the horizontal platforms of the first, inner boom member;
c. an activatable chain sprocket, which rotates upon actuation of the power source;
d. a drive roller chain, activatable by the chain sprocket;
e. a series of rollers in concert with a series of freely rotating gears fixedly attached to the bottom rollers to mobilize the bottom rollers in the same direction; and
f. a rotatable gear fixedly attached to the upper roller in such a manner as to drive the upper roller in a rotating direction opposite the direction of rotation of the bottom rollers thus causing the extension or retraction of the second, outer boom member relative to the first, inner boom member.

4. The telescoping boom sprayer of claim 1 wherein the drive assembly further comprises a rotatable boom center roller to assist the directional movement of the first, outer boom member.

5. The telescoping boom sprayer of claim 1 wherein the drive assembly further comprises a boom extension limit stop block fixed on the horizontal platforms at the distal end of the first, inner boom member to prevent further extension of the first, outer boom member.

6. The telescoping boom sprayer of claim 1 wherein the drive assembly further comprises an adjustable retraction stop mechanism to prevent retraction of the first, outer boom member beyond a desired location, wherein the adjustable retraction stop works in concert with a hydraulic stop switch.

7. The telescoping boom sprayer of claim 1 further comprising adjustment turnbuckles to adjust the frictional tension between the upper and bottom rollers.

8. The telescoping boom sprayer of claim 1 further comprising a pivoting breakaway system hingedly attached to the distal end of the second, outer boom member.

9. The telescoping boom sprayer of claim 1 further comprising a spray material supply conduit mounted to first, inner boom member and extending the entire length of the first, inner boom and second, outer boom members, and further comprising a plurality of spray nozzles positioned in spaced relationship along the entire length of the supply conduit and the first, inner boom and second, outer boom members.

10. The telescoping boom sprayer of claim 1 further comprising a suspension assembly positioned at the distal end of the first, inner boom member, the suspension assembly comprising:
a. a common spring shaft; and
b. a pair of arms having first and second ends wherein the first ends of the arms are rotatably connected to the common spring shaft, wherein the common spring shaft is connected to the first end of a suspension spring arm and the second end of the suspension spring arm is connected to a suspension spring assembly, wherein the suspension spring assembly comprises shock absorbing material to provide shock absorbance in either direction of travel by the second, outer boom member, wherein the second ends of the arms are attached to a common shaft upon which is connected a pair of opposing trolley bars, wherein each of the pair of trolley bars supports at least one pair of suspension wheels, wherein the suspension wheels support the bottom frame members of the second, outer boom member as the second, outer boom member either extends from or retracts into the first, inner boom member.

11. The telescoping boom sprayer of claim 10 further comprising a pair of flanged guide wheels situated on each side of the first, inner boom member to align the second, outer boom member with respect to the first, inner boom member.

12. The telescoping boom sprayer of claim 1 wherein the first, inner boom member is connected to a support vehicle.

13. The telescoping boom sprayer of claim 12 wherein the support vehicle includes a power source to activate the drive assembly.

14. The telescoping boom sprayer of claim 13 wherein the power source is hydraulic fluid power.

15. A telescoping boom sprayer comprising:
a. a first, inner boom member, wherein the first, inner boom section is an elongated rigid structure comprising a plurality of rigid elongated frame members extending the length of the first, inner boom member from a proximal end of the first, inner boom member to a distal end of the first, inner boom member, wherein the first, inner boom member comprises a pair of horizontal platforms extending substantially the length of the first, inner boom member; and
b. at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, and wherein the pair of horizontal platforms assist in extending, retracting and supporting the second, outer boom member; and
c. a suspension assembly positioned at the distal end of first, inner boom member, the suspension assembly comprising:
i. a common spring shaft;
ii. a pair of arms having first and second ends wherein the first ends of the arms are rotatably connected to the common spring shaft, wherein the common spring shaft is connected to the first end of a suspension spring arm and the second end of the suspension spring arm is connected to a suspension spring assembly, wherein the suspension spring assembly comprises shock absorbing material to provide shock absorbance in either direction of travel by the second, outer boom member, wherein the second ends of the arms are attached to a common shaft upon which is connected a pair of opposing trolley bars, wherein each of the pair of trolley bars supports at least one pair of suspension wheels, wherein the suspension wheels support the bottom frame members of the second, outer boom member as the second, outer boom member either extends from or retracts into the first, inner boom member.

16. A telescoping boom sprayer, comprising:
a. a first, inner boom member, wherein the first, inner boom section is an elongated rigid structure comprising a plurality of rigid elongated frame members extending the length of the first, inner boom member from a proximal end of the first, inner boom member to a distal end of the first, inner boom member, wherein the first, inner boom member comprises a pair of horizontal platforms extending substantially the length of the first, inner boom member;
b. at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, and wherein the pair of horizontal platforms assist in extending, retracting and supporting the second, outer boom member;
c. a drive assembly mounted onto the proximal end of the second, outer boom member, the drive assembly comprising a pinch roller system comprising at least one pair of bottom drive rollers, at least one upper pinch drive roller frictionally engaging the horizontal platforms of the first, inner boom member, and a power source to activate the drive assembly; wherein a pinch roller system comprises:
i. powered drive wheels to extend the second, outer boom member,
ii. two pairs of bottom drive rollers and at least one upper pinch drive roller, wherein the bottom drive rollers and the upper pinch roller frictionally engage the horizontal platforms of the first, inner boom member,
iii. an activatable chain sprocket, which rotates upon actuation of the power source, a drive roller chain, activatable by the chain sprocket,
iv. a series of rollers in concert with a series of freely rotating gears fixedly attached to the bottom rollers to mobilize the bottom rollers in the same direction,
v. a rotatable gear fixedly attached to the upper roller in such a manner as to drive the upper roller in a rotating direction opposite the direction of rotation of the bottom rollers thus causing the extension or retraction of the second, outer boom member relative to the first, inner boom member,
vi. a rotatable boom center roller to assist the directional movement of the first, outer boom member,
vii. a boom extension limit stop block fixed on the horizontal platforms at the distal end of the first, inner boom member to prevent further extension of the first, outer boom member, and
d. a suspension assembly positioned at the distal end of first, inner boom member, the suspension assembly comprising:
i. a common spring shaft;
ii. a pair of arms having first and second ends wherein the first ends of the arms are rotatably connected to the common spring shaft, wherein the common spring shaft is connected to the first end of a suspension spring arm and the second end of the suspension spring arm is connected to a suspension spring assembly, wherein the suspension spring assembly comprises shock absorbing material to provide shock absorbance in either direction of travel by the second, outer boom member, wherein the second ends of the arms are attached to a common shaft upon which is connected a pair of opposing trolley bars, wherein each of the pair of trolley bars supports at least one pair of suspension wheels, wherein the suspension wheels support the bottom frame members of the second, outer boom member as the second, outer boom member either extends from or retracts into the first, inner boom member; and
e. a spray material supply conduit mounted to first, inner boom member and extending the entire length of the first, inner boom and second, outer boom members, and further comprising a plurality of spray nozzles positioned in spaced relationship along the entire length of the supply conduit and the first, inner boom and second, outer boom members.

17. The telescoping boom sprayer of claim 16, wherein the power source is a hydraulic motor driven by a source of hydraulic fluid power from a support vehicle.

18. The telescoping boom sprayer of claim 16, wherein the first, inner boom member is connected to a support vehicle.

19. The telescoping boom sprayer of claim 18, wherein the support vehicle includes a power source to activate the drive assembly.

20. The telescoping boom sprayer of claim 16 wherein the power source is hydraulic fluid power.

21. A method of agricultural spraying with a telescoping boom sprayer, comprising:
a. providing at least one telescoping boom sprayer on a support vehicle, the boom sprayer including:
i. a first, inner boom member, wherein the first, inner boom section is an elongated rigid structure comprising a plurality of rigid elongated frame members extending the length of the first, inner boom member from a proximal end of the first, inner boom member to a distal end of the first, inner boom member, wherein the first, inner boom member comprises a pair of horizontal platforms extending substantially the length of the first, inner boom member;
ii. at least one second, outer boom member, wherein the second, outer boom member is an elongated, rigid structure comprising a plurality of rigid elongated frame members extending the length of the second outer boom member from a proximal end of the second, outer boom member to the distal end of the second, outer boom member, wherein the second, outer boom member is extendably housed within the first, inner boom member, and wherein the pair of horizontal platforms assist in extending, retracting and supporting the second, outer boom member;
iii. a drive assembly mounted onto the proximal end of the second, outer boom member, the drive assembly comprising a pinch roller system comprising at least one pair of bottom drive rollers, at least one upper pinch drive roller frictionally engaging the horizontal platforms of the first, inner boom member, and a power source to activate the drive assembly, and
iv. a suspension assembly positioned at the distal end of first, inner boom member, the suspension assembly comprising a common spring shaft, a pair of arms having first and second ends wherein the first ends of the arms are rotatably connected to the common spring shaft, wherein the common spring shaft is connected to the first end of a suspension spring arm and the second end of the suspension spring arm is connected to a suspension spring assembly, wherein the suspension spring assembly comprises shock absorbing material to provide shock absorbance in either direction of travel by the second, outer boom member, wherein the second ends of the arms are attached to a common shaft upon which is connected a pair of opposing trolley bars, wherein each of the pair of trolley bars supports at least one pair of suspension wheels, wherein the suspension wheels support the bottom frame members of the second, outer boom member as the second, outer boom member either extends from or retracts into the first, inner boom member;
b. providing a spray material supply conduit mounted to first, inner boom member and extending the entire length of the first, inner boom and second, outer boom members, and further comprising a plurality of spray nozzles positioned in spaced relationship along the entire length of the supply conduit and the first, inner boom and second, outer boom members;
c. actuating the drive assembly to extend the second, outer boom member to a desired location with respect to the first, inner boom member; and
d. actuating the spray nozzles.
